(19) United States
(12) Patent Application Publication
(10) Pub. No.: US 2018/0015503 A1
(43) Pub. Date: Jan. 18, 2018

(54) METHOD FOR ENCAPSULATING GLAZING IN POLYCARBONATE PROVIDED WITH AN ANTI-SCRATCH COATING

(71) Applicant: SAINT-GOBAIN GLASS FRANCE, Courbevoie (FR)

(72) Inventor: Sylvain THIMONIER, Estrees Saint Denis (FR)

(73) Assignee: SAINT-GOBAIN GLASS FRANCE, Courbevoie (FR)

(21) Appl. No.: 15/548,525

(22) PCT Filed: Dec. 8, 2015
(86) PCT No.: PCT/FR2015/053383

§ 371 Date: Aug. 3, 2017

(30) Foreign Application Priority Data
Feb. 5, 2015 (FR) 1550922

(51) Int. Cl. B05D 3/14; C08J 7/04; B05D 1/02; B05D 3/00

(52) U.S. Cl. CPC B05D 3/142; B05D 3/007; C08J 7/042; B05D 1/02; C08J 2423/28; C08J 2483/04; C08J 2369/00

(57) ABSTRACT

The present invention relates to a process for encapsulating a polycarbonate glazing comprising, on at least one of its faces, a silicone-based abrasion-resistant hardcoat, said process comprising the following successive steps:
(a) the treatment of a region of the face of the glazing bearing the silicone-based hardcoat by atmospheric plasma with a plasma nozzle, the distance between the end of the plasma nozzle and the surface of the glazing being at most equal to 7 mm,
(b) the application, to said region treated by atmospheric plasma, of a primer composition comprising one or more adhesion promoters selected from diisocyanates, polyisocyanates and chlorinated polyolefins, in solution or suspension in an organic or aqueous solvent,
(c) the evaporation of the solvent so as to form a dry primer layer, and
(d) the overmolding of a thermoplastic polymer over the region covered by the dry primer layer.

The present invention relates to a novel process for encapsulating motor vehicle glazings made of polycarbonate which comprises an atmospheric plasma pretreatment step.

In the industrial field of motor vehicle glazings, the term “encapsulation” denotes a process or a step of overmolding a polymer material around the perimeter of a glazing. The material is injected in the fluid state into a mold forming a leaktight frame around the edge of the glazing. After curing the material by a polymerization and/or crosslinking reaction (the case for thermosetting polymers) or by cooling (the case for thermoplastic polymers), the mold is opened and removed, leaving, at the periphery of the glazing, a profiled bead in contact with the edge and at least one of the two faces of the glazing, often with both faces of the glazing.

The polymer forming the profiled bead is often an elastomer capable of acting as a seal between the glazing and the body. Polymers which are not elastomers may however also be overmolded by encapsulation in order to play other roles. The profiled bead obtained is then generally a composite bead simultaneously comprising juxtaposed non-elastomer elements and elastomer elements.

The encapsulation step is generally preceded by a step of cleaning and activating the surface to be overmolded, at the periphery of the glazing, then a primer is applied to the activated region intended to come into contact with the overmolded profiled bead.

In the field of motor vehicle glazings made of mineral glass, it is known to use activation by plasma at atmospheric pressure, also referred to as cold plasma. The oxidation of the surface results in the formation of reactive groups, predominantly SiOH groups, capable of reacting with the primer.

In the field of motor vehicle glazings made of polycarbonate, this technique of plasma activation, before priming and encapsulation, has not until now made it possible to obtain satisfactory results.

Polycarbonate is a material used as a replacement for silicate glass for certain glazings such as glazed roofs, fixed side windows and rear windows, and also for the diffusing glass of headlamps. Despite numerous advantages (low weight, impact resistance, ease of forming) polycarbonate suffers, as a replacement material for motor vehicle glass, from a high sensitivity to scratching.

All polycarbonate motor vehicle glazings must therefore be coated with an anti-scratching and anti-scoring transparent hardcoat in order to guarantee a sufficient transparency of the glazing throughout the life of the vehicle.

These coatings are nanocomposites based on silicone (polyorganosiloxanes) and on nanoparticules with a high hardness, generally silica particles. They are hydrophobic coatings having a surface energy of less than 30 mN/m and a thickness of the order of several hundred nanometers (100-1000 nm).

When it is desired to encapsulate polycarbonate glazings protected by such abrasion-resistant/anti-scratching coatings, commonly denoted by the term hardcoats, the difficult problem of activating this surface, which is very hard, chemically inert and difficult to wet, is faced. The known atmospheric plasma treatment used successfully for mineral glass does not enable the activation of the surfaces of the hardcoats covering the polycarbonate glazings.

No satisfactory chemical treatment is known either that makes it possible to improve the wettability of the surface of the silicone-based hardcoats, to increase the roughness thereof and to introduce therein chemical functions capable of reacting with the components of the primer (isocyanates).

Until now, the only satisfactory technique that makes it possible to obtain a good adhesion of the priming compositions and of the injection-molded encapsulation materials is the removal of the hardcoat by mechanical abrasion of the surfaces to be encapsulated. This technique however poses a certain number of problems:
the fine plastic dust may be inhaled by nearby operators;
the mechanical abrasion extends the cycle time and imposes large constraints for the layout of the production zone (closed chamber, extraction system);
the dust generated by the mechanical abrasion may be deposited on the plastic glazings and create unacceptable defects after encapsulation;
numerous preventative cleaning operations are necessary.

Within the context of its research aiming to replace the mechanical abrasion of hardcoats on polycarbonates, the applicant observed with surprise that a known technique, until now judged to be inefficient, made it possible to achieve this objective provided that it is used under uncustomary conditions.

The atmospheric plasma technique is specifically used industrially with nozzle/substrate to be activated distances of between around 1 and 5 cm depending on the material to be treated, on the power of the plasma, on the size of the nozzle and on the rate of travel. It was by carrying out tests of activation by cold plasma with much smaller nozzle/substrate distances that the inventor became aware that this known technique made it possible, contrary to what had been observed to date, to increase the surface energy and the roughness of the treated regions and to introduce thereinto, especially by oxidation, chemical functions capable of reacting with the priming compositions.

Contrary to what had been feared, this abrasion by “close” cold plasma did not lead to any thermal degradation of the glazings treated. In addition it made it possible to shorten the cycle time and considerably reduce the costs linked to the encapsulation. The absence of formation of dust constitutes a considerable advantage from the point of view of the environment and the health of the operators.

In order to obtain satisfactory adhesion results between a polycarbonate glazing and an overmolding bead made of thermoplastic polymer (the curing of which in the encapsulation mold does not involve a chemical reaction) it has additionally been necessary to carry out priming of the plasma-treated region. Certain priming agents have proved particularly satisfactory from this point of view.

The subject of the present invention is a process for encapsulating a polycarbonate glazing comprising, on at least one of its faces, a silicone-based abrasion-resistant hardcoat, said process comprising the following successive steps:

(a) the treatment of a region of the face of the glazing bearing the silicone-based hardcoat by atmospheric plasma with a plasma nozzle having a power preferably of between 100 voltamperes and 1000 voltamperes, the distance between the end of the plasma nozzle and the surface of the glazing being at most equal to 7 mm,

(b) the application, to said region treated by atmospheric plasma, of a primer composition comprising one or more adhesion promoters selected from diisocyanates, polyisocyanates and chlorinated polyolefins, in solution or suspension in an organic or aqueous solvent,

(c) the evaporation of the solvent so as to form a dry primer layer, and

(d) the overmolding of a thermoplastic polymer over the region covered by the dry primer layer.

In the present application, the terms “plasma nozzle” and “plasma torch” are used interchangeably to denote a plasma source that generates a post-discharge not in thermal equilibrium.

The expression “distance between the end of the plasma nozzle and the surface of the glazing” is understood to mean the shortest distance between the outlet orifice of the plasma jet and the surface of the hardcoat to be treated.

The plasma nozzle preferably has a power of between 200 and 900 voltamperes, in particular between 300 and 800 voltamperes, and ideally between 400 and 700 voltamperes.

The plasma nozzle may be a rotatable nozzle where the outlet orifice of the plasma jet rotates at high speed about the central axis of the nozzle. In such a rotatable nozzle, the axis of the plasma jet may be normal to the surface to be treated, but it may also be inclined relative to this normal. The cone angle formed by an inclined jet of a rotatable nozzle is generally between 10 and 30°, in particular between 12 and 20°. The axis of the plasma jet is preferably inclined outward, which has the effect of increasing the region treated.

Such rotatable plasma nozzles are sold for example under the name Openair® by Plasmatreat.

The rotatable nozzles have the advantage of allowing the treatment of relatively wide regions at the edge of the glazing. The width of the strip that may be treated in a single pass of the nozzle is more or less equal to the diameter of the circle of rotation of the orifice of the nozzle.

Use will preferably be made of rotatable nozzles that make it possible to treat, in a single pass, a strip having a width of between 1 and 5 cm, preferably between 1.5 and 4 cm and particularly preferably between 2 and 3 cm.

The distance between the end of the plasma nozzle and the surface of the glazing is preferably less than 6 mm, in particular at most equal to 5 mm, and ideally between 2 mm and 4 mm.

In step (a) of the process according to the invention, the plasma torch is moving relative to the glazing to be treated. This movement may be created owing to a movable torch and a fixed substrate or else owing to a fixed torch and a movable substrate which travels in front of this fixed torch, the latter embodiment being preferred.

The rate of relative movement of the plasma nozzle with respect to the glazing is preferably between 1 and 5 m/minute, in particular between 2 and 4 m/minute. Within these ranges, use will generally be made of an even greater rate of relative movement when the distance between the end of the nozzle and the substrate to be treated is short.

The plasma nozzle typically operates with a carrier gas pressure of between 3 and 4 bar. The carrier gas is preferably filtered air.

The process of the present invention in principle encompasses embodiments where the plasma torch passes several times over a same region of the substrate to be treated. When this is the case, the nozzle-substrate distance and the rate of movement may be identical for all the passes. One and/or the other may however be different from one pass to another. When step (a) of the process comprises several passes of the torch over a same region of the substrate, it is essential that at least one pass takes place under the conditions defined in the independent claim. The other pass(es) could take place under other conditions, in particular at a greater nozzle-substrate distance.

Preferably, step (a) comprises only a single pass of the plasma nozzle over each point of the glazing to be treated.

The cold plasma treatment (step (a)) increases the surface energy, and therefore the wettability of the silicone-based hardcoat. Before treatment, this surface energy is less than 30 mN·m⁻¹.

After the plasma treatment step according to the invention, it is at least equal to 45 mN·m⁻¹, preferably greater than 50 mN·m⁻¹ and ideally greater than 60 mN·m⁻¹.

In a second step of the process according to the invention, a primer composition is applied to the plasma-treated region.

This composition is a liquid composition containing one or more adhesion promoters in solution or suspension in an organic or aqueous solvent.

The application may be carried out according to known application techniques, for example using a felt or foam material impregnated by the primer composition, or else by application of a spray using a sprayer.

The thickness of the primer film, before drying, is preferably less than 300 μm, in particular between 20 μm and 200 μm.

The drying may be carried out at ambient temperature or under slight heating, it is preferably carried out at ambient temperature.

After the drying step, the dry primer layer formed on the plasma-treated region generally has a thickness of less than 30 μm, in particular between 2 and 20 μm.

The adhesion promoter(s) is (are) selected from the group consisting of diisocyanates, polyisocyanates and chlorinated polyolefins. Aliphatic diisocyanates or polyisocyanates allow particularly effective priming.

The total content of diisocyanates and polyisocyanates of the primer composition is generally between 20 and 40% by weight, preferably between 25 and 38% by weight and in particular between 30 and 35% by weight.

The content of chlorinated polyolefins of the primer composition is generally between 5 and 25% by weight, preferably between 7 and 20% by weight and in particular between 10 and 15% by weight.

In one particularly advantageous embodiment, the adhesion promoters are selected from the group consisting of isophorone diisocyanate (IPDI), 4,4′-diphenylmethane diisocyanate (MDI) and maleic anhydride-grafted chlorinated polyolefin.

The chlorinated polyolefins preferably have a chlorine content of between 5 and 20% by weight, preferably between 10 and 15% by weight, and their weight-average mass is preferably between 50 000 and 200 000, preferably between 80 000 and 120 000.

These polyolefins are available on the market and are sold for example under the references Eastman Chlorinated Polyolefin (Eastman), Superchlon (Nippon Paper) and Hardlen (Toyobo).

After evaporation of the solvent phase, the edge of the glazing, with the plasma-treated region(s) covered with the dry primer layer, is surrounded by a mold and a thermoplastic polymer is injected in the molten state.

The thermoplastic polymer is selected, for example, from styrenic thermoplastic elastomers (TPE-S), vulcanized olefinic thermoplastic elastomers (TPE-V), poly(vinyl chloride), thermoplastic polyurethanes (TPU), poly(methyl methacrylate) (PMMA), polycarbonates (PC), polystyrene (PS), acrylonitrile-butadiene-styrene (ABS), polycarbonate/acrylonitrile-butadiene-styrene (PC/ABS) blends and polypropylene (PP).

Among these thermoplastic polymers, use will preferably be made of elastomers, in particular styrenic thermoplastic elastomers (TPE-S), vulcanized olefinic elastomers (TPE-V) and plasticized polyvinyl chloride) (PVC).

The TPE-S elastomers that can be used in the present invention mainly comprise the following families:
SBS (styrene-butadiene-styrene): block copolymers comprising a central polybutadiene block flanked by two polystyrene blocks,
SEBS (styrene-ethylene-butadiene-styrene): copolymers obtained by hydrogenation of SBS copolymers,
SEPS (styrene-ethylene-propylene-styrene): copolymers comprising a central poly(ethylene-propylene) block flanked by two polystyrene blocks,
SEEPS (styrene-ethylene-ethylene-propylene-styrene): copolymers obtained by hydrogenation of styrene-butadiene/isoprene-styrene copolymers.

These polymers are available on the market as grades that contain mineral fillers, but also in the form of filler-free materials.

In the present invention, use will be made of TPE elastomers that are essentially free of fillers, or that contain less than 5% of mineral fillers, preferably less than 2% of mineral fillers.

They are available, for example, under the following trade names: Dryflex (Hexpol TPE), Evoprene (AlphaGary), Sofprene (SOFTER), Laprene (SOFTER), Asaprene (Asahi Kasei), Nilflex (Taroplast).

These products may contain a certain fraction of organic lubricants, thinners or plasticizers.

The melting point of TPE-S elastomers is advantageously between 180° C. and 210° C., in particular between 190° C. and 200° C.

In the molten state, they must be sufficiently fluid to be able to be injection molded. It is however impossible to give precise indications regarding their melt viscosity since this depends not only on the temperature but also on the shear stress to which the polymers are subjected. Suppliers generally propose “injection moldable” qualities.

Vulcanized olefinic elastomers (TPE-V, or TPV according to the ISO 18064 standard) are blends of a thermoplastic polymer, generally polypropylene (PP), and of a rubber, typically EPDM, crosslinked while being manufactured by extrusion. Due to this vulcanization during extrusion, these polymers are also known as “dynamic vulcanizates”. The rubbery phase is dispersed in the thermoplastic matrix.

By way of example of commercially available TPE-V elastomers, mention may be made of Sarlink® 4775B42 (Teknor Apex Co).

Plasticized PVCs, or flexible PVCs, contain large amounts of plasticizers, typically between 40 and 60% by weight. The melting point thereof is between 160 and 200° C.

By way of example of plasticized PVCs used advantageously as encapsulation polymers, mention may be made of the following products available on the market:

BENVIC® (Solvay), TECHNIFAX® (Littleford Day), NAKAN® (Resinoplast), SUNPRENE® (Mitsubishi).

### EXAMPLE

Samples of polycarbonate glazing covered with a silicone-based hardcoat (Basecoat Silfort SHP 470+AS4700, Momentive) are passed under an Openair® (Plasmatreat) plasma torch with a rotatable nozzle (diameter of 22 mm, exit angle of 14°, outward inclination) having an output power of 500 voltamperes.

The plasma torch operates with filtered air under a pressure of between 3 and 4 bar. The plasma torch is fixed and the edge of the samples is made to travel in front of the end of the torch at a speed of 2 m/minute.

The edge of each sample undergoes a single pass under the plasma torch. The distances between the surface of the glazing and the end of the nozzle are indicated in table 1. The axis of the torch is normal relative to the plane of the glazing.

After a single pass of the sample under the plasma torch, the surface energy (wettability) of the treated region is measured in accordance with the ISO 8296 standard with an ethanol-based test solution. The values obtained are indicated in table 1.

Each of the primer compositions below is then applied to the plasma-treated region:

IPDI CPO-w: Isophorone diisocyanate+chlorinated polyolefin in water (LOCTITE TP661 (Henkel))
CPO-s: Chlorinated polyolefin in a xylene/ethylbenzene mixture (KORATAC GM510 (Kömmerling))
CPO-w: Chlorinated polyolefin in water (HARDLEN EW5515 (Toyobo))
IPDI-w: Isophorone diisocyanate in water (WITCOBOND 434-27 (Baxenden))
IPDI-s: Isophorone diisocyanate in an n-butyl acetate/ethyl acetate/butanone mixture (SIKA 209N (Sika))
IPDI-MDI-s: Isophorone diisocyanate and 4,4′-diphenylmethane diisocyanate in an ethyl acetate/butanone mixture (SIKA 209D (Sika))

The application is carried out using a foam material impregnated with the primer composition.

The solvent is left to evaporate at ambient temperature, the edge of the samples of glazing is introduced into an encapsulation mold and is overmolded either with a TPE-V (Sarlink® 4775B42, from Teknor Apex Co.) or with a plasticized PVC (APEX® 1523F3, from Teknor Apex Co.).

No preheating of the glazing is carried out between the priming step and the encapsulation.

After encapsulation, the samples are stored for 7 days at 23° C. and 50% relative humidity, then are subjected to the following accelerated aging conditions: 14 days at 70° C. and at 95% relative humidity, then two hours at −20° C.

The quality of the adhesive contact is evaluated by a 90° peel test (pull rate of 100 mm/min). The peel strength in N/cm and the percentage of adhesive or cohesive failure in accordance with the ASTM-D413 standard are measured.

Table 1 shows all of the results obtained.

The comparative samples without plasma treatment were simply cleaned with isopropanol.

TABLE 1
Peel strength and type of failure (cohesive or adhesive) of the
adhesive contact as a function of the distance between nozzle and surface
and of the primer composition used

| Distance | | | | | |
|---|---|---|---|---|---|
| between torch | | | | Peel strength | |
| and surface of | Surface | | | after accelerated | |
| the hardcoat | energy | | Encapsulation | aging test | |
| (mm) | (mN/m) | Priming | polymer | (N/cm) | Type of failure |
| 2 | >60 | IPDI + CPO_{w} | TPE-V | >70 | 100% CF* |
| 2 | >60 | CPOₛ | TPE-V | >65 | 100% CF |
| 2 | >60 | CPO_{w} | TPE-V | >70 | 100% CF |
| 2 | >60 | IPDI_{w} | PVC | >50 | 45% CF/55% AF |
| 2 | >60 | IPDIₛ | PVC | >75 | 100 CF |
| 2 | >60 | IPDI + MDIₛ | PVC | >30 | 100 AF** |
| 4 | 54 | IPDI + CPO_{w} | TPE-V | >30 | 40% CF/60% AF |
| 4 | 54 | CPOₛ | TPE-V | >20 | 30% CF/70% AF |
| 4 | 54 | CPO_{w} | TPE-V | >30 | 40% CF/60% AF |
| 4 | 54 | IPDI_{w} | PVC | >10 | 100% AF |
| 4 | 54 | IPDIₛ | PVC | >40 | 70% CF/30% AF |
| 4 | 54 | IPDI + MDIₛ | PVC | >10 | 100% AF |
| 8 | 36 | IPDI + CPO_{w} | TPE-V | 0 | 100% AF |
| 4 | 36 | CPOₛ | TPE-V | 0 | 100% AF |
| 8 | 36 | CPO_{w} | TPE-V | 0 | 100% AF |
| 8 | 36 | IPDI_{w} | PVC | 0 | 100% AF |
| 8 | 36 | IPDIₛ | PVC | >20 | 100% AF |
| 8 | 36 | IPDI + MDIₛ | PVC | 0 | 100% AF |
| Without plasma | <30 | IPDI + CPO_{w} | TPE-V | 0 | 100% AF |
| Without plasma | <30 | CPOₛ | TPE-V | 0 | 100% AF |
| Without plasma | <30 | CPO_{w} | TPE-V | 0 | 100% AF |
| Without plasma | <30 | IPDI_{w} | PVC | 0 | 100% AF |
| Without plasma | <30 | IPDIₛ | PVC | >10 | 100% AF |
| Without plasma | <30 | IPDI + MDIₛ | PVC | 0 | 100% AF |

*CF = cohesive failure
**AF = adhesive failure

It is observed that in the samples according to the invention where the is distance between the nozzle and the surface of the hardcoat is 2 and 4 mm, all the peel strength values are greater than 10 mN/m.

On the contrary, for the samples that have not undergone any plasma treatment or that have undergone a plasma treatment with a torch/substrate distance of 8 mm, the peel strength is insufficient in the vast majority of cases.

It is furthermore observed that the peel strength is higher for the samples treated at a distance of 2 mm than for those treated at a distance of 4 mm.

The surface energy of the samples after plasma treatment is even greater when the nozzle/surface distance is small.

1. A process for encapsulating a polycarbonate glazing comprising, on at least one of its faces, a silicone-based abrasion-resistant hardcoat, said process comprising:
(a) treating a region of the face of the glazing bearing the silicone-based hardcoat by atmospheric plasma with a plasma nozzle having a power of between 100 voltamperes and 1000 voltamperes, wherein a distance between the end of the plasma nozzle and the surface of the glazing is at most equal to 7 mm, thereby obtaining a region treated by atmospheric plasma,
(b) applying, to the region treated by atmospheric plasma, a primer composition comprising at least one adhesion promoter selected from the group consisting of diisocyanates, polyisocyanates, and chlorinated polyolefins, in solution or suspension in an organic or aqueous solvent,
(c) evaporating the solvent, thereby forming a dry primer layer, and
(d) overmolding a thermoplastic polymer over the region covered by the dry primer layer.

2. The process as claimed in claim 1, wherein the rate of relative movement of the plasma nozzle with respect to the glazing is between 2 and 4 m/minute.

3. The process as claimed in claim 1, wherein the distance between the end of the plasma nozzle and the surface of the glazing is less than 6 mm.

4. The process as claimed in claim 1, wherein the plasma nozzle operates with a carrier gas.

5. The process as claimed in claim 1, wherein the adhesion promoter is at least one selected from the group consisting of isophorone diisocyanate (IPDI), 4,4′-diphenylmethane diisocyanate (MDI) and maleic anhydride-grafted chlorinated polyolefin.

6. The process as claimed in claim 5, wherein the primer composition essentially consists of the at least one adhesion promoter selected from the group consisting of diisocyanates, polyisocyanates and chlorinated polyolefins, in solution or suspension in an organic or aqueous solvent.

7. The process as claimed in claim 1, wherein the thermoplastic polymer is selected from the group consisting of styrenic thermoplastic elastomers (TPE-S), vulcanized olefinic thermoplastic elastomers (TPE-V), poly(vinyl chloride), thermoplastic polyurethanes (TPU), poly(methyl methacrylate) (PMMA), polycarbonates (PC), polystyrene (PS), acrylonitrile-butadiene-styrene (ABS), polycarbonate/acrylonitrile-butadiene-styrene (PC/ABS) blends and polypropylene (PP).

8. The process as claimed in claim 1, wherein the thermoplastic polymer is an elastomer.

9. The process as claimed in claim 4, wherein the plasma nozzle operates with filtered air as the carrier gas at a pressure of between 3 and 4 bar.

10. The process as claimed in claim 1, wherein the thermoplastic polymer is a thermoplastic elastomer or a poly(vinyl chloride).

11. The process as claimed in claim 1, wherein the surface energy of the region before treatment by atmospheric plasma is less than 30 mN/m.

12. The process as claimed in claim 1, wherein the surface energy of the region after treatment by atmospheric plasma is at least 45 mN/m.

13. The process as claimed in claim 1, wherein a peel strength of the thermoplastic polymer overmolded over the region covered by the dry primer layer is capable of storage for 14 days at 70° C. and at 95% relative humidity, then two hours at −20° C., while maintaining a peel strength of at least 10 N/cm.

14. The process as claimed in claim 1, wherein the silicone-based hardcoat has not been subjected to mechanical abrasion.

15. The process as claimed in claim 1, wherein the plasma nozzle is a rotatable nozzle having a cone angle of between 10 and 30°.

16. The process as claimed in claim 1, wherein the treating of the region of the face of the glazing bearing the silicone-based hardcoat by atmospheric plasma comprises passing the plasma nozzle over the same region of the substrate more than once.

17. The process as claimed in claim 1, wherein the treating of the region of the face of the glazing bearing the silicone-based hardcoat by atmospheric plasma comprises passing the plasma nozzle over the same region of the substrate over each point of the glazing at most one time.

18. The process as claimed in claim 1, wherein a thickness of the primer composition applied to the region treated by atmospheric plasma, prior to evaporating the solvent, is less than 300 μm.

19. The process as claimed in claim 1, wherein the dry primer layer has a thickness of less than 30 μm.

20. The process as claimed in claim 1, wherein a content of filler, if present, in the thermoplastic polymer is less than 5%.

21. The process as claimed in claim 3, wherein the distance between the end of the plasma nozzle and the surface of the glazing is at most equal to 5 mm.

22. The process as claimed in claim 21, wherein the distance between the end of the plasma nozzle and the surface of the glazing is between 2 mm and 4 mm.
